(19) United States
(12) Patent Application Publication
(10) Pub. No.: US 2024/0270221 A1
(43) Pub. Date: Aug. 15, 2024

(54) ELECTRO-HYDRAULIC BRAKING SYSTEM FOR VEHICLE AND VEHICLE INCLUDING THE SAME

(71) Applicant: Volvo Car Corporation, Göteborg (SE)

(72) Inventors: Yongxing Jin, Shanghai (CN); Jiangliu Su, Shanghai (CN)

(21) Appl. No.: 18/425,229

(22) Filed: Jan. 29, 2024

(30) Foreign Application Priority Data
Feb. 9, 2023 (CN) 202310099874.6

(51) Int. Cl. B60T 8/94; B60T 13/66

(52) U.S. Cl. CPC B60T 8/94; B60T 13/662; B60T 2270/402

(57) ABSTRACT

An electro-hydraulic braking system for a vehicle integrated in a single module and a vehicle including the same. The electro-hydraulic braking system includes: a main hydraulic loop including a set of basic valves for operating in a conventional braking mode; a standby hydraulic loop including a set of standby valves for operating in a redundant braking mode; a motor pump component shared by the main hydraulic loop and the standby hydraulic loop, and configured to provide braking pressure for driving circulation of brake fluid; and an electronic control module configured to control the set of basic valves, the set of standby valves and the motor pump component in response to a braking need.

### CROSS-REFERENCE TO RELATED APPLICATION

The present disclosure claims the benefit of priority of co-pending Chinese Patent Application No. 202310099874.6, filed on Feb. 9, 2023, and entitled “ELECTRO-HYDRAULIC BRAKING SYSTEM FOR VEHICLE AND VEHICLE INCLUDING THE SAME,” the contents of which are incorporated in full by reference herein.

### TECHNICAL FIELD

The present disclosure relates to the field of automobile braking system, and more particularly, to an electro-hydraulic braking system for vehicle integrated in a single module and a vehicle including the same.

### BACKGROUND

In recent years, automatic driving technology has achieved rapid development and presented a trend close to practicality. An electro-hydraulic braking system is a common vehicle braking system in automatic driving application scenarios at present. Generally, in order to ensure braking safety for a vehicle employing automatic driving technology, in addition to setting a main hydraulic braking system in the vehicle to provide braking capability under conventional circumstances, it is also required to additionally set a standby hydraulic braking system to guarantee to operate instead of the main hydraulic braking system in the case that there is a failure in it, so as to realize redundant braking under fault circumstances.

However, the existing main hydraulic braking system and standby hydraulic braking system are two modules independent of each other and connected through pipelines, which leads to a high cost for the whole braking system and requires a long assembling time during manufacturing. Moreover, the arrangement of the two modules is not compact enough so that they occupy a large space, and their great weight affects the endurance of the vehicle.

Therefore, there is a need for a new type of electro-hydraulic braking system with redundant braking function integrated in a single module, so as to lower the overall cost as well as the weight and volume for the braking system.

### SUMMARY

In order to solve the above problems, the present disclosure provides an electro-hydraulic braking system for vehicle integrated in a single module and a vehicle including the same.

According to one aspect of the present disclosure, there is provided an electro-hydraulic braking system for vehicle integrated in a single module, including: a main hydraulic loop including a set of basic valves for operating in a conventional braking mode; a standby hydraulic loop including a set of standby valves for operating in a redundant braking mode; a motor pump component shared by the main hydraulic loop and the standby hydraulic loop, and configured to provide braking pressure for driving circulation of brake fluid; and an electronic control module configured to control the set of basic valves, the set of standby valves and the motor pump component in response to a braking need.

According to an example of the present disclosure, the electronic control module includes a first microcontroller unit and a second microcontroller unit that are located on a same circuit board, where the first microcontroller unit is configured to control the set of basic valves and the motor pump component in the conventional braking mode, and the second microcontroller unit is configured to control the set of standby valves and the motor pump component in the redundant braking mode.

According to an example of the present disclosure, the electronic control module further includes a first power interface and a first communication bus interface that are dedicated to the first microcontroller unit, and a second power interface and a second communication bus interface that are dedicated to the second microcontroller unit.

According to an example of the present disclosure, the electronic control module further includes a sensor signal interface shared by the first microcontroller unit and the second microcontroller unit.

According to an example of the present disclosure, the first microcontroller unit and the second microcontroller unit employ a lockstep architecture in the conventional braking mode to achieve synchronization.

According to an example of the present disclosure, the second microcontroller unit is further configured to execute braking control instructions together with the first microcontroller unit in the conventional braking mode to obtain an operational result, where the operational result of the second microcontroller unit is used for checking with the operational result of the first microcontroller unit.

According to an example of the present disclosure, the electronic control module further includes an internal interface for communication between the first microcontroller unit and the second microcontroller unit.

According to an example of the present disclosure, the main hydraulic loop is used to deliver braking pressure to brakes of four wheels of the vehicle in the conventional braking mode, and the standby hydraulic loop is used to deliver braking pressure to brakes of two front wheels of the vehicle in the redundant braking mode.

According to an example of the present disclosure, the electro-hydraulic braking system is configured to operate in the conventional braking mode by default, and switch to the redundant braking mode in response to the occurrence of a braking failure, and the second microcontroller unit is configured to start to control the set of standby valves and the motor pump component in response to a braking failure notification.

According to another aspect of the present disclosure, there is provided a vehicle including: wheel brakes; and the electro-hydraulic braking system as described above, configured to control the braking pressure provided to the wheel brakes.

The electro-hydraulic braking system for vehicle according to the embodiments of the present disclosure integrates all components in the original main hydraulic braking system and the standby hydraulic braking system into a single module, thereby facilitating layout for the braking system in the vehicle and saving overall assembling time for the system. Moreover, having the main hydraulic loop and the standby hydraulic loop share the same motor pump component reduces overall size and weight for the braking system and lowers cost for the braking system. In addition, the first microcontroller unit and the second microcontroller unit included in the electronic control module receive power supply independently of each other and perform communicative transmission independently, so that they can each perform braking control independently, thereby better guaranteeing the realization of redundant braking function to improve safety for vehicle's running. In addition, the two microcontroller units operate in a synchronous state by employing the lockstep architecture in the conventional braking mode, and thus the operational result synchronously calculated by the second microcontroller unit may be used for checking with the operational result of the first microcontroller unit, thereby finding the operational error based on the difference between both operational results to further improve accuracy and safety for braking control.

### BRIEF DESCRIPTION OF THE DRAWINGS

The accompanying drawings are used to provide a further understanding of the embodiments of the present disclosure and constitute a part of the specification, and together with the embodiments of the present disclosure, serve to explain the present disclosure, and do not constitute a limitation to the present disclosure. In the accompanying drawings, like reference numerals generally represent like parts or steps.

FIG. 1 shows a structural schematic diagram of an electro-hydraulic braking system in the prior art.

FIG. 2 shows a modular schematic diagram of an electro-hydraulic braking system according to an embodiment of the present disclosure.

FIG. 3 shows a modular schematic diagram of an electronic control module according to an embodiment of the present disclosure.

FIG. 4 shows an example of a structural schematic diagram of a hydraulic loop according to an embodiment of the present disclosure.

### DETAILED DESCRIPTION

In order to facilitate the details provided above, the following specification is provided to enable those skilled in the art to understand, manufacture and use the invention as described herein and explicitly claimed herein. Because the specific combinations of various features will produce a large number of practical embodiments in which the present disclosure can be practiced, and for the purpose of providing reasonably clear and concise specification, only preferred embodiments will be presented herein. However, it should be recognized that those skilled in the art can similarly practice other embodiments not explicitly described herein. In this way, any assessment with respect to the scope of the present disclosure should be made for the claims explicitly provided herein, and the scope of the present disclosure should be interpreted in consideration of this specification in its broadest and reasonable interpretation and in consideration of the common knowledge and technical level in the art. Nothing in this specification is intended to limit the spirit and scope of the present disclosure.

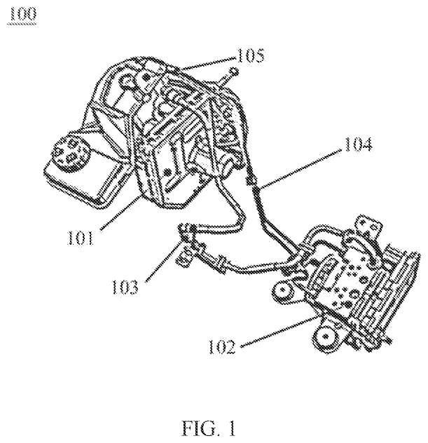

FIG. 1 shows a structural schematic diagram of an electro-hydraulic braking system in the prior art. As shown in FIG. 1, an existing electro-hydraulic braking system 100 includes a main hydraulic braking system 101 that operates under conventional circumstances and a standby hydraulic braking system 102 that provides redundant braking under fault circumstances, as well as a fluid filling pipeline 103 and a braking pipeline 104 that are connected between them. Among other things, the main hydraulic braking system 101 and the standby hydraulic braking system 102 each include an independent motor pump component, valve components and an electronic control unit, and thus the cost of the whole braking system 100 is high, has a large weight and occupies a large space. In addition, as shown in FIG. 1, since the main hydraulic braking system 101 and the standby hydraulic braking system 102 share a brake fluid reservoir 105 disposed on one side of the main hydraulic braking system 101, in order to guarantee that the standby hydraulic braking system 102 can be replenished with brake fluid, generally the main hydraulic braking system 101 must be arranged higher than the standby hydraulic braking system 102 in the Z-axis direction, which also brings difficulties to the layout of the whole braking system 100. Additionally, in the manufacturing process, it is required to assemble the main hydraulic braking system 101 and the standby hydraulic braking system 102 as well as the pipelines between them, respectively, and thus it takes a long assembling time.

To this regard, according to the embodiments of the present disclosure, there is provided an electro-hydraulic braking system for vehicle with redundant braking function, which integrates all components in the original main hydraulic braking system and the standby hydraulic braking system into a single module to provide a braking system with compact structure, light weight and lower cost.

It should be noted that the electro-hydraulic braking system may further include other components not described herein, such as wheel cylinders installed inside the wheels, and the like, but in order to avoid obscuring the focus of the present disclosure, the description of these components is omitted hereinafter.

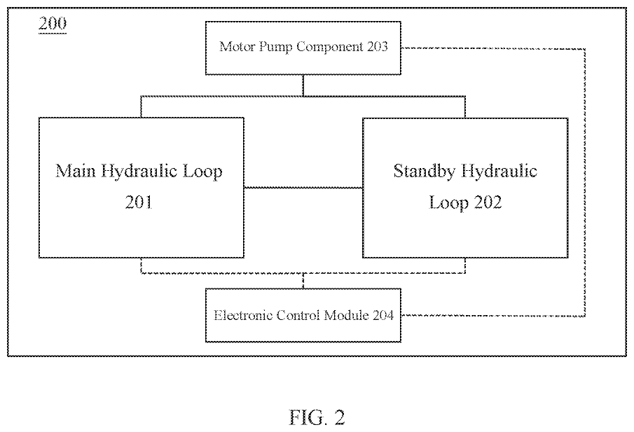

An electro-hydraulic braking system for vehicle according to an embodiment of the present disclosure will be described below with reference to the accompanying drawings. FIG. 2 shows a modular schematic diagram of an electro-hydraulic braking system 200 according to an embodiment of the present disclosure. As shown in FIG. 2, the electro-hydraulic braking system 200 integrated in a single module may include a main hydraulic loop 201 originally disposed in the main hydraulic braking system and a standby hydraulic loop 202 originally disposed in the standby hydraulic braking system. Among other things, the main hydraulic loop 201 may include a set of basic valves (not shown) for operating in a conventional braking mode, and the standby hydraulic loop 202 may include a set of standby valves (not shown) for operating in a redundant braking mode.

In addition, as further shown in FIG. 2, the electro-hydraulic braking system 200 further includes a motor pump component 203 shared by the main hydraulic loop 201 and the standby hydraulic loop 202, and the motor pump component 203 may be configured to provide braking pressure for driving the brake fluid to circulate. As described above, in the original braking system, the main hydraulic braking system and the standby hydraulic braking system each include an independent motor pump component. In the braking system according to the embodiment of the present disclosure, however, by integrating the main hydraulic loop and the standby hydraulic loop into a single module and having them share the same motor pump component to provide braking pressure, the overall size and weight of the braking system can be reduced, and the cost for the braking system can be lowered. Among other things, the solid lines between the main hydraulic loop 201, the standby hydraulic loop 202 and the motor pump component 203 shown in FIG. 2 represent that there are pipeline connections between them, and these pipeline connections enable the brake fluid to circulate between these modules via pipelines. It should be noted that the pipeline connections represented by the solid lines in the figure is schematic, and does not represent that there is only one pipeline between these modules. Moreover, a suitable number of pipelines may be disposed between the main hydraulic loop 201, the standby hydraulic loop 202 and the motor pump component 203 as required on the basis of the embodiment of the present disclosure, which is not limited herein.

In addition, as further shown in FIG. 2, the electro-hydraulic braking system 200 further includes an electronic control module 204 to control the set of basic valves in the main hydraulic loop 201, the set of standby valves in the standby hydraulic loop 202 and the motor pump component 203 in response to a braking need. That is, an electronic control module with dual control channels is provided according to the embodiment of the present disclosure, in which one channel may be used to act as a main controller, so as to control the set of basic valves in the main hydraulic loop 201 and the motor pump component 203 to realize a basic braking function; whereas the other channel may be used to act as a standby controller, so as to operate instead of the main controller in the case that a braking failure occurs, to control the set of standby valves in the standby hydraulic loop 202 and the motor pump component 203 to realize a redundant braking function. Among other things, the dotted lines between the main hydraulic loop 201, the standby hydraulic loop 202 and the motor pump component 203 and the electronic control module 204 shown in FIG. 2 represent that there are electrical connections between them, so that the control signals generated by the electronic control module 204 can be delivered to the valve components in the main hydraulic loop 201 and the standby hydraulic loop 202 and the motor pump component 203 via the electrical connections. Likewise, the electrical connections represented by dotted lines in the figure are schematic, and do not limit the form and number of actual physical connection lines.

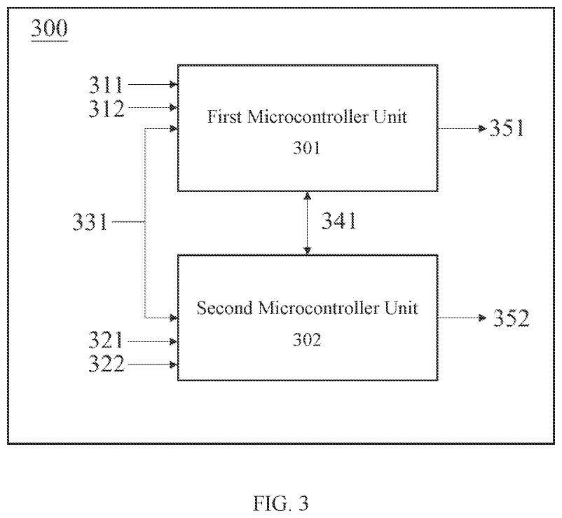

Next, specific details of the electronic control module in the electro-hydraulic braking system according to the embodiment of the present disclosure will be described. FIG. 3 shows a modular schematic diagram of an electronic control module 300 according to an embodiment of the present disclosure. As shown in FIG. 3, the electronic control module 300 according to the embodiment of the present disclosure may include a first microcontroller unit 301 and a second microcontroller unit 302 that are located on a same circuit board (not shown), in which the first microcontroller unit 301 may be configured to control the set of basic valves and the motor pump component in the conventional braking mode, and the second microcontroller unit 302 may be configured to control the set of standby valves and the motor pump component in the redundant braking mode. That is, the electro-hydraulic braking system according to the embodiment of the present disclosure may be configured to operate in the conventional braking mode by default, and in the conventional braking mode, only the first microcontroller unit 301 acting as the main controller generates a control command to control the actions of the set of basic valves and the motor pump component, thereby providing the conventional/basic braking function. In the case that a braking failure occurs, however, the electro-hydraulic braking system according to the embodiment of the present disclosure may switch to the redundant braking mode in response to the occurrence of braking failure, and in the redundant braking mode, the second microcontroller unit 302 acting as the standby controller operates instead of the first microcontroller unit 301, and the second microcontroller unit 302 may start to control the set of standby valves and the motor pump component to provide the redundant braking function in response to a braking failure notification (e.g., received from a vehicle controller).

In this example, as shown in FIG. 3, the electronic control module 300 may further include a first power interface 311 and a first communication bus interface 312 that are dedicated to the first microcontroller unit 301, and a second power interface 321 and a second communication bus interface 322 that are dedicated to the second microcontroller unit 302. The first power interface 311 and the second power interface 321 may be connected to different power sources (not shown) respectively, so that they are used to supply power to the first microcontroller unit 301 and the second microcontroller unit 302 respectively, thereby providing the power required by the first microcontroller unit 301 and the second microcontroller unit 302. The first communication bus interface 312 and the second communication bus interface 322 may be respectively used to connect the first microcontroller unit 301 and the second microcontroller unit 302 to the vehicle-mounted communication buses corresponding thereto, so that the first microcontroller unit 301 and the second microcontroller unit 302 receive various data and commands (e.g., delivered from the vehicle controller). In this example, since the first microcontroller unit 301 and the second microcontroller unit 302 have their own power interfaces and communication bus interfaces respectively, so as to independently receive power supply and independently perform communicative transmission, they can accomplish the control function independently of each other, and the failure of the first microcontroller unit 301 will not affect the second microcontroller unit 302 acting as the standby controller to operate instead of it, thereby better guaranteeing the realization of redundant braking function to improve safety for vehicle's running.

Optionally, the electronic control module 300 may further include a sensor signal interface 331 shared by the first microcontroller unit 301 and the second microcontroller unit 302. The sensor signal interface 331 may be used to connect to an on-board sensor, such as a sensor for sensing a degree of wear of the brake pad, a level of the fluid reservoir, a hand brake signal or a wheel speed, etc., so as to receive a sensing result from the sensor. Considering the cost efficiency, duplicate sensors are usually not equipped for the redundant braking, and thus the first microcontroller unit 301 and the second microcontroller unit 302 according to the embodiment of the present disclosure may share the sensor signal interface 331 to receive the sensing result from the same sensor. It should be noted that while only one sensor signal interface 331 is shown in FIG. 3, the present disclosure is not limited to this, but a larger number of sensor signal interfaces can be set as specifically required, so as to be connected with different sensors respectively.

Optionally, the first microcontroller unit 301 and the second microcontroller unit 302 may employ a lockstep architecture in the conventional braking mode to achieve synchronization. That is, in the conventional braking mode, the first microcontroller unit 301 and the second microcontroller unit 302 may execute the same braking control instruction based on the received various data in full synchronization based on the lockstep architecture, so as to obtain their own operational results. While in the conventional braking mode, only the first microcontroller unit 301 will finally output the corresponding control command based on its operational result, so as to control the operation of the valve components and the motor pump component, the operational result synchronously calculated by the second microcontroller unit 302 may be used for checking with the operational result of the first microcontroller unit 301, thereby finding the operational error based on the difference between both operational results to improve accuracy and safety for braking control. It should be noted that a certain fault tolerance rate may be set for different operational results. For example, in the case that the degree of sameness of the operational results reaches a certain percentage, the two microcontroller units may be considered to have obtained the same operational results. In one example, the first microcontroller unit 301 may be configured to acquire the operational result synchronously calculated by the second microcontroller unit 302, compare it with the operational result calculated by itself, and if both are the same, output a control command based on its operational result, and if the operational results are different, stop outputting control commands and perform a re-calculation. In another example, when it is found that the operational results are different, the first microcontroller unit 301 may not perform the re-calculation, but average its own operational result and the operational result of the second microcontroller unit 302 to obtain a new operational result, and output a control command based on the new operational result, thereby saving amount of calculation and response time.

Optionally, as further shown in FIG. 3, the electronic control module 300 may further include an internal interface 341 for communication between the first microcontroller unit 301 and the second microcontroller unit 302. In the original braking system, the main hydraulic braking system and the standby hydraulic braking system are two independent modules and include their own controllers, and there is no direct interaction between their controllers. According to the embodiment of the present disclosure, however, via the internal interface 341, the first microcontroller unit 301 and the second microcontroller unit 302 can deliver various data such as a synchronization command to each other, thereby realizing intra-module communication. It should be noted that while only a single internal interface 341 is shown in FIG. 3, the present disclosure is not limited to this, and a larger number of internal interfaces for communication between the first microcontroller unit 301 and the second microcontroller unit 302 can be set as specifically required.

In addition, the electronic control module 300 may further include output interfaces 351 and 352 for the first microcontroller unit 301 and the second microcontroller unit 302 to output control commands. Likewise, the number of output interfaces is not limited herein.

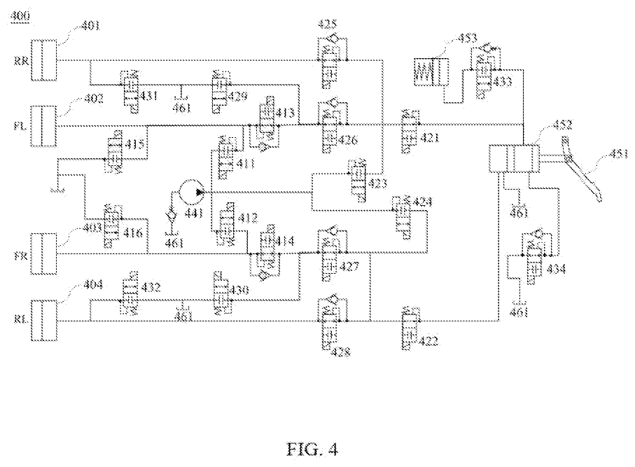

FIG. 4 shows an example of a structural schematic diagram of a hydraulic loop according to an embodiment of the present disclosure. As shown in FIG. 4, the hydraulic loop 400 according to the embodiment of the present disclosure may include a plurality of valves, in which valves 421-434 (shown in a non-filling manner in FIG. 4) may act as the set of basic valves that operate in the conventional braking mode, whereas valves 411-416 (shown in a filling manner in FIG. 4) may act as the set of standby valves that operate in the redundant braking mode. In addition, FIG. 4 further shows pipeline connections between these valves for circulation of brake fluid in solid lines. Therefore, the valves 421-434 and the pipelines connected therebetween can constitute an example of the main hydraulic loop as described above, whereas the valves 411-416 and the pipelines connected therebetween can constitute an example of the standby hydraulic loop as described above. In addition, FIG. 4 further shows a motor pump component 441 shared by the main hydraulic loop and the standby hydraulic loop, which may be used to provide braking pressure for driving the brake fluid to circulate.

Additionally, FIG. 4 further shows brakes 401-404 of four wheels of the vehicle, in which the letters RR, FL, FR and RL represent the brakes 401-404 respectively corresponding to the wheels located in the right rear, the left front, the right front and the left rear positions. In the example of the hydraulic loop provided in FIG. 4, the brakes 401-404 corresponding to the four wheels are all connected with the main hydraulic loop (in which the brakes 402-403 of the two front wheels are connected with the main hydraulic loop via the valves 413-414 in the standby hydraulic loop respectively), whereas only the brakes 402-403 corresponding to the two front wheels are connected with the standby hydraulic loop. Therefore, in this example, the main hydraulic loop may be used to deliver the braking pressure to the brakes of the four wheels of the vehicle in the conventional braking mode, whereas the standby hydraulic loop may be used to deliver the braking pressure to the brakes of the two front wheels of the vehicle in the redundant braking mode. However, the present disclosure is not limited to this. For example, it is also possible to connect the brakes of the two rear wheels with the standby hydraulic loop so as to deliver the braking pressure to them in the redundant braking mode.

With continued reference to FIG. 4, which further shows a brake pedal 451, a main cylinder 452 and a pedal feeling simulator 453 which are common in the braking system, and the details thereof are omitted herein. As described above, each of the valve components and the motor pump component shown in FIG. 4 may be controlled by the electronic control module as described above to realize the respective braking functions. For example, in the conventional braking mode, the first microcontroller unit in the electronic control module may control the valves 421-434 to realize the following operations of the valve components: the valves 421 and 422 acting as isolation valves may be closed to prevent the high-pressure brake fluid flowing out of the motor pump from flowing to the main cylinder; the valves 423 and 424 acting as inlet valves may be opened to allow the brake fluid to flow into the wheel cylinders; the valves 425-428 acting as booster valves correspond to the four wheels respectively, and can be opened to allow the brake fluid to flow into the wheel cylinder of the corresponding wheel, and when a certain wheel cylinder needs to relieve or maintain the pressure, the corresponding valve of the valves 425-428 may be closed to prevent the pressure of the wheel cylinder from increasing continuously; the valves 429-432 acting as pressure relief valves correspond to the four wheels respectively, and may be closed to prevent the brake fluid from flowing out of the wheel cylinders, and when a certain wheel cylinder needs to relieve the pressure, the corresponding valve of the valves 429-432 may be opened to allow the brake fluid to flow into the fluid reservoir, reducing the pressure of the wheel cylinder; the valve 433 acting as a simulation valve may be opened to feed back the feeling of simulating the brake pedal; the valve 434 acting as a diagnosis valve may support a diagnostic function. In addition, the valves 411-416 are kept opened in the conventional braking mode (i.e., in the normally open state), and in the redundant braking mode, the second microcontroller unit in the electronic control module may control the valves 411-416 to realize the following operations of the valve components: the valves 411-412 acting as inlet valves may be opened to allow the brake fluid to flow into the front wheel cylinders; the valves 413-414 acting as isolation valves may be closed to prevent the high-pressure brake fluid from flowing to the main cylinder and the rear wheel cylinders; the valves 415-416 acting as pressure relief valves correspond to the two front wheels respectively, and may be closed to prevent the brake fluid from flowing out of the front wheel cylinders, and when a certain front wheel cylinder needs to relieve the pressure, the corresponding valve of the valves 415-416 may be opened to allow the high-pressure brake fluid to flow into the fluid reservoir, reducing the pressure of the front wheel cylinder. It should be noted that the number, connective relationship and operation mode of the valve components shown in FIG. 4 are only schematic, and can be changed as required, which is not limited herein. In addition, FIG. 4 further shows that certain nodes in the hydraulic loop are connected to the fluid reservoir 461. It should be noted that while a plurality of marks 461 are shown in FIG. 4 for convenience of drawing, these marks all refer to the same one fluid reservoir, that is, these nodes are all connected to the same one fluid reservoir 461.

As such, the electro-hydraulic braking system according to the embodiments of the present disclosure integrates the components in the original main hydraulic braking system and the standby hydraulic braking system into a single module, thereby facilitating layout for the braking system in the vehicle and saving overall assembling time for the system. Moreover, having the main hydraulic loop and the standby hydraulic loop share the same motor pump component reduces overall size and weight for the braking system and lowers cost for the braking system. In addition, the electro-hydraulic braking system according to the embodiments of the present disclosure further includes an electronic control module with dual control channels, in which a first microcontroller unit for one channel which acts as the main controller and a second microcontroller unit for the other channel can control the valve components in the main hydraulic loop and the standby hydraulic loop respectively, and both microcontroller units receive power supply independently of each other and perform communicative transmission independently, so that they can each perform braking control independently, thereby better guaranteeing the realization of redundant braking function to improve safety for vehicle's running. In addition, the two microcontroller units operate in a synchronous state by employing the lockstep architecture in the conventional braking mode, and thus the operational result synchronously calculated by the second microcontroller unit may be used for checking with the operational result of the first microcontroller unit, thereby finding the operational error based on the difference between both operational results to further improve accuracy and safety for braking control.

Furthermore, according to another aspect of the present disclosure, there is further provided a vehicle, including: wheel brakes; and the electro-hydraulic braking system described above, configured to control the braking pressure provided to the wheel brakes. For example, as described above, the main hydraulic loop in the electro-hydraulic braking system may be used to transmit the braking pressure to the brakes of four wheels of the vehicle in the conventional braking mode, whereas the standby hydraulic loop in the electro-hydraulic braking system may be used to transmit the braking pressure to the brakes of two front wheels of the vehicle in the redundant braking mode.

Of course, the above specific embodiments are only exemplary rather than restrictive, and those skilled in the art can consolidate and combine some steps and devices from various embodiments above described separately according to the concept of the present disclosure to achieve the effects of the present disclosure. Such consolidated and combined embodiments are further included in the present disclosure, and such consolidation and combinations will not be described herein.

Note that the advantages, strengths, effects, etc. mentioned in the present disclosure are only examples rather than limitations, and these advantages, strengths, effects, etc. cannot be considered as necessary for various embodiments of the present disclosure. Additionally, the specific details of the above invention are only for the purpose of example and for the convenience of easy understanding, but not for limitation, and the above details do not limit the present disclosure as having to be realized by employing the above specific details.

The block diagrams of devices, apparatuses, equipment and systems involved in the present disclosure only act as illustrative examples and are not intended to require or imply that they must be connected, arranged and configured in the manner shown in the block diagrams. As those skilled in the art will recognize, these devices, apparatuses, equipment and systems can be connected, arranged and configured in arbitrary manner. Words such as “including”, “containing”, “having” etc., are open terms, referring to “including but not limited to” and can be used interchangeably therewith. The terms “or” and “and” as used herein refer to the terms “and/or” and can be used interchangeably therewith, unless explicitly indicated otherwise in the context. The term “such as” as used herein refers to the phrase “such as but not limited to” and can be used interchangeably therewith.

Additionally, the steps and devices in various embodiments herein are not only limited to being carried out in a certain embodiment, and in fact, part of steps and part of devices relevant in various embodiments herein can be combined to conceive new embodiments according to the concepts of the present disclosure, and these new embodiments are further included in the scope of the present disclosure.

The various illustrated logic blocks, modules, and circuits as described can be implemented or performed with a general-purpose processor, a digital signal processor (DSP), an ASIC, a field programmable gate array signal (FPGA) or other programmable logic device (PLD), a discrete gate or transistor logic, a discrete hardware component, or any combination thereof designed to perform the functions described herein. A general-purpose processor can be a microprocessor, but as an alternative, the processor can be any commercially available processor, controller, microcontroller or state machine. A processor can also be implemented as a combination of computing devices, such as a combination of a DSP and a microprocessor, a plurality of microprocessors, one or more microprocessors cooperating with a DSP core, or any other such configuration.

The described functions can be implemented in hardware, software, firmware or any combination thereof. If implemented in software, the functions may be stored as one or more instructions on a non-transitory, tangible computer-readable medium. A storage medium can be any available tangible medium that can be accessed by a computer. By way of example and not limitation, such computer-readable media may include RAM, ROM, EEPROM, CD-ROM or other optical disk storage, magnetic disk storage or other magnetic storage devices, or any other tangible media that can be used to carry or store desired program codes in the form of instructions or data structures and that can be accessed by a computer. As used herein, a disc includes a compact disc (CD), a laser disc, an optical disc, a digital versatile disc (DVD), a floppy disc and a Blu-ray disc.

Therefore, a computer program product can perform the operations given herein. For example, such a computer program product can be a non-transitory computer-readable tangible medium having instructions tangibly stored (and/or encoded) thereon that are executable by one or more processors to perform the operations described herein. The computer program product may include packaged materials.

Software or instructions can also be transmitted through a transmission medium. For example, software can be transmitted from websites, servers or other remote sources using a transmission medium such as coaxial cable, fiber optic cable, twisted pair, digital subscriber line (DSL) or wireless technology such as infrared, radio or microwave.

Other examples and implementations are within the scope and spirit of the present disclosure and the appended claims. For example, due to the nature of software, the functions described above can be implemented using software executed by a processor, hardware, firmware, hard wiring or any combination thereof. The features implementing functions can also be physically located at various locations, including being distributed so that parts of functions are implemented at different physical locations. Moreover, as used herein, including as used in the claims, the “or” used in the enumeration of items starting with “at least one” indicates a separate enumeration, so that, for example, the enumeration of “at least one of A, B or C” means A or B or C, or AB or AC or BC, or ABC (e.g., A and B and C). Furthermore, the wording “exemplary” does not mean that the described examples are preferred or better than other examples.

Various changes, substitutions and modifications to the technologies described herein can be made without departing from the taught technologies defined by the appended claims. In addition, the scope of the claims of the present disclosure is not limited to the specific aspects of the above-described processing, machines, manufacturing, and compositions, means and actions of events. The processing, machines, manufacturing, and compositions, means or actions of events that currently exist or are to be developed later can be utilized to perform substantially the same functions or achieve substantially the same results as the corresponding aspects described herein. Accordingly, the appended claims include such processing, machines, manufacturing, and compositions, means or acts of events that are within their scope.

The above description of the inventive aspects is provided to enable any skilled in the art to make or use the present disclosure. Various modifications to these aspects will be very apparent to those skilled in the art, and the general principles defined herein can be applied to other aspects without departing from the scope of the present disclosure. Therefore, the present disclosure is not intended to be limited to the aspects shown herein, but is to be accorded the widest scope consistent with the principles and novel features of the invention herein.

The above description has been presented for purposes of illustration and description. Furthermore, this description is not intended to limit the embodiments of the present disclosure to the forms of the invention herein. Although plenty of example aspects and embodiments have been discussed above, those skilled in the art will recognize certain variations, modifications, changes, additions and sub combinations thereof.

What is claimed is:

1. An electro-hydraulic braking system for a vehicle integrated in a single module, the electro-hydraulic braking system comprising:
a main hydraulic loop comprising a set of basic valves for operating in a braking mode;
a standby hydraulic loop comprising a set of standby valves for operating in a redundant braking mode;
a motor pump component shared by the main hydraulic loop and the standby hydraulic loop, and configured to provide braking pressure for driving circulation of brake fluid; and
an electronic control module configured to control the set of basic valves, the set of standby valves and the motor pump component in response to a braking need.

2. The electro-hydraulic braking system of claim 1, wherein the electronic control module comprises a first microcontroller unit and a second microcontroller unit that are located on a same circuit board, wherein the first microcontroller unit is configured to control the set of basic valves and the motor pump component in the braking mode, and the second microcontroller unit is configured to control the set of standby valves and the motor pump component in the redundant braking mode.

3. The electro-hydraulic braking system of claim 2, wherein the electronic control module further comprises a first power interface and a first communication bus interface that are dedicated to the first microcontroller unit, and a second power interface and a second communication bus interface that are dedicated to the second microcontroller unit.

4. The electro-hydraulic braking system of claim 3, wherein the electronic control module further comprises a sensor signal interface shared by the first microcontroller unit and the second microcontroller unit.

5. The electro-hydraulic braking system of claim 2, wherein the first microcontroller unit and the second microcontroller unit employ a lockstep architecture in the braking mode to achieve synchronization.

6. The electro-hydraulic braking system of claim 5, wherein the second microcontroller unit is further configured to execute braking control instructions together with the first microcontroller unit in the braking mode to obtain an operational result, wherein the operational result of the second microcontroller unit is used for checking with the operational result of the first microcontroller unit.

7. The electro-hydraulic braking system of claim 2, wherein the electronic control module further comprises an internal interface for communication between the first microcontroller unit and the second microcontroller unit.

8. The electro-hydraulic braking system of claim 1, wherein the main hydraulic loop is used to deliver the braking pressure to brakes of four wheels of the vehicle in the braking mode, and the standby hydraulic loop is used to deliver the braking pressure to brakes of two front wheels of the vehicle in the redundant braking mode.

9. The electro-hydraulic braking system of claim 2, wherein the electro-hydraulic braking system is configured to operate in the braking mode by default, and switch to the redundant braking mode in response to an occurrence of a braking failure, and the second microcontroller unit is configured to start to control the set of standby valves and the motor pump component in response to a braking failure notification.

10. A vehicle comprising:
wheel brakes; and
an electro-hydraulic braking system configured to control braking pressure provided to the wheel brakes, wherein the electro-hydraulic braking system comprises:
a main hydraulic loop comprising a set of basic valves for operating in a braking mode;
a standby hydraulic loop comprising a set of standby valves for operating in a redundant braking mode;
a motor pump component shared by the main hydraulic loop and the standby hydraulic loop, and configured to provide braking pressure for driving circulation of brake fluid; and
an electronic control module configured to control the set of basic valves, the set of standby valves and the motor pump component in response to a braking need.

11. The vehicle of claim 10, wherein the electronic control module comprises a first microcontroller unit and a second microcontroller unit that are located on a same circuit board, wherein the first microcontroller unit is configured to control the set of basic valves and the motor pump component in the braking mode, and the second microcontroller unit is configured to control the set of standby valves and the motor pump component in the redundant braking mode.

12. The vehicle of claim 11, wherein the electronic control module further comprises a first power interface and a first communication bus interface that are dedicated to the first microcontroller unit, and a second power interface and a second communication bus interface that are dedicated to the second microcontroller unit.

13. The vehicle of claim 12, wherein the electronic control module further comprises a sensor signal interface shared by the first microcontroller unit and the second microcontroller unit.

14. The vehicle of claim 11, wherein the first microcontroller unit and the second microcontroller unit employ a lockstep architecture in the braking mode to achieve synchronization.

15. The vehicle of claim 14, wherein the second microcontroller unit is further configured to execute braking control instructions together with the first microcontroller unit in the braking mode to obtain an operational result, wherein the operational result of the second microcontroller unit is used for checking with the operational result of the first microcontroller unit.

16. The vehicle of claim 11, wherein the electronic control module further comprises an internal interface for communication between the first microcontroller unit and the second microcontroller unit.

17. The vehicle of claim 10, wherein the main hydraulic loop is used to deliver the braking pressure to brakes of four wheels of the vehicle in the braking mode, and the standby hydraulic loop is used to deliver the braking pressure to brakes of two front wheels of the vehicle in the redundant braking mode.

18. The vehicle of claim 11, wherein the electro-hydraulic braking system is configured to operate in the braking mode by default, and switch to the redundant braking mode in response to an occurrence of a braking failure, and the second microcontroller unit is configured to start to control the set of standby valves and the motor pump component in response to a braking failure notification.
